(19) United States
(12) Patent Application Publication
(10) Pub. No.: US 2022/0301278 A1
(43) Pub. Date: Sep. 22, 2022

(54) IMAGE PROCESSING METHOD AND APPARATUS, STORAGE MEDIUM, AND ELECTRONIC DEVICE

(71) Applicant: Alibaba (China) Co., Ltd., Hangzhou (CN)

(72) Inventors: Yanheng LU, Shanghai (CN); Junwen LUO, Shanghai (CN)

(21) Appl. No.: 17/698,859

(22) Filed: Mar. 18, 2022

(30) Foreign Application Priority Data
Mar. 19, 2021 (CN) 202110297577.3

(51) Int. Cl. G06V 10/25; G06V 10/82; G06V 10/62; G06V 10/94

(52) U.S. Cl. CPC G06V 10/25; G06V 10/82; G06V 10/62; G06V 10/94; G06V 2201/07

(57) ABSTRACT

The present invention discloses an image processing method and apparatus, a storage medium, and an electronic device. The method includes: obtaining a to-be-processed image and sensing data corresponding to the to-be-processed image; obtaining region-of-interest information of the to-be-processed image based on the sensing data; determining a first image region and a second image region of the to-be-processed image based on the region-of-interest information, wherein the first image region is an image region determined based on the region-of-interest information, and the second image region is an image region other than the first image region in the to-be-processed image; and processing the first image region in a first processing manner, and processing the second image region in a second processing manner, wherein computation complexity of the first processing manner is higher than that of the second processing manner. The present invention resolves a technical problem of conventional image processing methods that it is hard to improve overall image processing performance while ensuring image quality of a region of interest.

### TECHNICAL FIELD

The present invention relates to the field of image processing, and in particular, to an image processing method and apparatus, a storage medium, and an electronic device.

### BACKGROUND

As the rising of living standards, people express stronger demands for high-definition pictures. As a result of rapid development of the digital imaging technology over the past few decades, with improved processing algorithms, cameras and imaging chips currently mounted on mobile phones are able to deliver superior picture quality that was implemented by high-end SLR cameras decades ago.

However, with ever-increasing numbers of camera pixels and people's ever-increasing demands of better image quality, the complexity and the computation workload of image signal processing has been increasing rapidly, which imposes extremely high requirements for design of image signal processing modules, especially real-time processing modules. However, for an image processing method in the current art, it is hard to improve overall computing performance while ensuring image quality of a region of interest.

There is a need for an efficient solution to the foregoing problem.

### SUMMARY

Embodiments of the present invention provide an image processing method and apparatus, a storage medium, and an electronic device, so as to at least resolve a technical problem that conventional image processing methods cannot improve overall image processing performance while ensuring image quality of a region of interest.

According to an aspect of the embodiments of the present invention, an image processing method is provided, including: obtaining a to-be-processed image and sensing data corresponding to the to-be-processed image; obtaining region-of-interest information of the to-be-processed image based on the sensing data; determining a first image region and a second image region of the to-be-processed image based on the region-of-interest information, wherein the first image region is an image region determined based on the region-of-interest information, and the second image region is an image region other than the first image region in the to-be-processed image; and processing the first image region in a first processing manner, and processing the second image region in a second processing manner, wherein computation complexity of the first processing manner is higher than that of the second processing manner.

According to another aspect of the embodiments of the present invention, an image processing apparatus is provided, including: a first obtaining module, configured to obtain a to-be-processed image and sensing data corresponding to the to-be-processed image; a second obtaining module, configured to obtain region-of-interest information of the to-be-processed image based on the sensing data; a determining module, configured to determine a first image region and a second image region of the to-be-processed image based on the region-of-interest information, wherein the first image region is an image region determined based on the region-of-interest information, and the second image region is an image region other than the first image region in the to-be-processed image; and a processing module, configured to process the first image region in a first processing manner, and process the second image region in a second processing manner, wherein computation complexity of the first processing manner is higher than that of the second processing manner.

According to another aspect of the embodiments of the present invention, a graphics processing unit is further provided, including: a sensing data processing unit, configured to obtain a to-be-processed image and sensing data corresponding to the to-be-processed image; and obtain region-of-interest information of the to-be-processed image based on the sensing data; an image data processing unit, configured to: determine a first image region and a second image region of the to-be-processed image based on the region-of-interest information, and process the first image region in a first processing manner and process the second image region in a second processing manner, so as to obtain a processed image, wherein the first image region is an image region determined based on the region-of-interest information, the second image region is an image region other than the first image region in the to-be-processed image, and computation complexity of the first processing manner is higher than that of the second processing manner; and an output unit, configured to output the processed image.

According to another aspect of the embodiments of the present invention, an image processing system is further provided, including: a graphics processing unit, and a memory that is connected to the graphics processing unit and configured to provide the graphics processing unit with instructions for performing the following processing steps: obtaining a to-be-processed image and sensing data corresponding to the to-be-processed image; obtaining region-of-interest information of the to-be-processed image based on the sensing data; determining a first image region and a second image region of the to-be-processed image based on the region-of-interest information, wherein the first image region is an image region determined based on the region-of-interest information, and the second image region is an image region other than the first image region in the to-be-processed image; and processing the first image region in a first processing manner, and processing the second image region in a second processing manner, wherein computation complexity of the first processing manner is higher than that of the second processing manner.

According to another aspect of the embodiments of the present invention, a non-volatile storage medium is further provided, and the non-volatile storage medium includes a stored program, wherein when the program is executed, a device in which the non-volatile storage medium is located is controlled to perform the image processing method according to any one of the foregoing aspects.

In the embodiments of the present invention, the to-be-processed image and the sensing data corresponding to the to-be-processed image are obtained; the region-of-interest information of the to-be-processed image is obtained based on the sensing data; the first image region and the second image region are determined based on the region-of-interest information, wherein the first image region is an image region determined based on the region-of-interest information, and the second image region is an image region other than the first image region in the to-be-processed image; and the first image region is processed in the first processing manner, and the second image region is processed in the second processing manner, wherein computation complexity of the first processing manner is higher than that of the second processing manner.

In the embodiments of the present application, the region-of-interest information is obtained based on the sensing data corresponding to the to-be-processed image, so as to properly allocate limited computing power and increase complexity of an image processing algorithm for a core sensitive region in the region-of-interest information. In this way, the core sensitive area presents higher image processing quality, to further improve overall processing performance of image processing.

Therefore, the embodiments of the present invention achieve the goal of improving overall image processing performance and yet still ensuring the image quality of regions of interests, and thus realize the technical effects of balancing image processing complexity and computation load. Furthermore, the problem of unable to improve overall image processing performance in the premise of ensuring image quality of regions of interests in conventional techniques can be resolved.

### BRIEF DESCRIPTION OF DRAWINGS

The accompanying drawings described herein are intended for better understanding of the present invention, and constitute a part of the present application. Exemplary embodiments and descriptions thereof in the present invention are intended to interpret the present invention and do not constitute any improper limitation on the present invention. In the accompanying drawings:

FIG. 1 is a flowchart of an image processing method according to an embodiment of the present invention;

FIG. 2 is a schematic diagram of an implementation structure of an optional image processing method according to an embodiment of the present invention;

FIG. 3 is a schematic diagram of optional event extraction according to an embodiment of the present invention;

FIG. 4 is a block diagram of a hardware structure of a computer terminal (or a mobile device) for implementing an image processing method according to an embodiment of the present invention;

FIG. 5 is a schematic structural diagram of an image processing apparatus according to an embodiment of the present application;

FIG. 6 is a schematic structural diagram of a graphics computing processor according to an embodiment of the present application; and

FIG. 7 is a structural block diagram of another computer terminal according to an embodiment of the present application.

### DETAILED DESCRIPTION OF EMBODIMENTS

For better understanding of the technical solutions in the present invention, the following description of the technical solutions in the embodiments of the present invention is provided with reference to the accompanying drawings. The described embodiments are merely some but not all of the embodiments of the present invention. All other embodiments obtained by a person of ordinary skill in the art based on the embodiments of the present invention without creative efforts shall fall within the protection scope of the present invention.

It should be noted that in the specification, claims, and accompanying diagrams of the present invention, the terms such as “first” and “second” are intended to distinguish between similar objects but do not necessarily indicate a specific order or sequence. It should be understood that the data used in this way is interchangeable in appropriate circumstances so that the embodiments of the present invention described herein can be implemented in other orders than the order illustrated or described herein. Moreover, the terms “include”, “have” and any other variants mean to cover the non-exclusive inclusion, for example, a process, method, system, product, or device that includes a list of steps or units is not necessarily limited to those units, but may include other units not expressly listed or inherent to such a process, method, product, or device.

First, some nouns or terms in the description of the embodiments of the present application are interpreted as follows:

Region of interest (region of interest, ROI): In the field of image processing, a region of interest is a special image region selected from an image and the region of interest is a focus for image analysis, and the region of interest is delineated for further processing. Using the region of interest to delineate a target to be specially processed can lead to less processing time and higher accuracy.

Event sensor (event sensor): also known as a dynamic vision sensor or silicon retina, is an imaging sensor capable of responding to local changes in brightness. Different from an ordinary camera, an event camera does not use a shutter to capture images. Instead, each pixel in the event camera operates independently and asynchronously, and when brightness of the scene changes, signals are outputted to reflect the changes. Otherwise, it remains silent.

Image signal processing (ISP): is a module used in a chip to process output signals from a front-end image sensor. Its main function is to perform a series of processing, such as denoising, demosaicing, white balance, and defect pixel correction, on raw format images inputted by the sensor, and then output image information to be used later.

Spiking neural network (SNN-SpikingNeuronNetworks): is a third generation neural network model, and implements a higher level of biological neural simulation. In addition to neuron and synaptic states, the SNN also incorporates a concept of time into its operation. Therefore, its neurons are activated when a specific accumulated value is reached, instead of being activated in each iterative propagation. When one neuron is activated, one signal may be generated and transferred to other neurons, to increase or decrease its accumulated value. Because of this characteristic, the SNN is particularly suitable for processing signals output by the event sensor.

In the technical field of the present application, although a picture may contain a lot of information, information provided by all pixels is not equally important. Considering the heavy burden of existing image processing, overall performance could be significantly improved by focusing limited computation resource on regions of interests, increasing computation complexity of the regions of interest and using more sophisticated algorithms to improve quality of the regions of interest.

In the field of vision sensors, event-driven vision sensors are also developing rapidly. Especially in recent years, event sensors have gradually entered the commercial market from the laboratory. Unlike conventional sensors, the event sensor outputs an event signal only when brightness changes, and such event signal can be useful in many fields after further processing. Considering a region in which an event occurs with high probability is a region of interest, using the event sensor to provide region-of-interest information can help improve performance of the entire image signal processing module.

Regions of interest are widely used in the field of computer vision. For example, with region-of-interest (ROI) information, more bits are allocated to a more important region during video image compression, so as to improve image quality of the ROI region and significantly improve subjective quality of image videos.

Conventional ROI search algorithms such as the Viola-Jones algorithm or currently popular deep learning-based algorithms (such as FasterR-CNN, YOLO, and SSD) have obvious computing power problems. Therefore, in the prior art, a ROI search algorithm based on recognition and detection is proposed to implement a computing speed up to 1500 FPS on a CPU.

It should be noted that the foregoing region-of-interest extraction scheme in the prior art, although having been optimized, still requires relatively large computation load. In a case of deployment in an IOT device, there would be problems of relatively large computation load and power consumption. In addition, the foregoing region-of-interest extraction scheme is usually implemented based on a YUV color format or RGB color format obtained through color conversion. In the image signal processing ISP module, an input data stream in the RAW format is converted to the YUV color format or RGB color format after several stages of processing. For example, input data in an example ISP pipeline is in the raw format of non-image file, and the data is converted into an RGB format through processing such as defect pixel correction (DPC), denoise, white balance, and demosaicing (CFAI). In this case, more than half of the processing processes have been completed, thus it is of little significance to apply the ROI technology subsequently. Therefore, the ROI technology is generally not applied at ISP front end, regardless of a pipeline position or the computation load consideration.

### Embodiment 1

An image processing method according to the embodiments of the present invention is provided. It should be noted that the steps shown in the flowchart of the accompanying drawing may be executed in a computer system with a set of computer-executable instructions, and although a logical order is shown in the flowchart, steps shown or described may be performed in a different order in some cases.

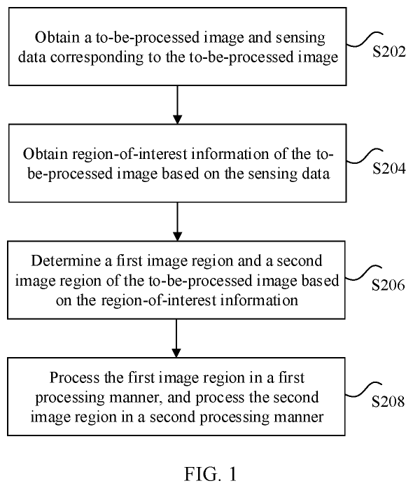

The present invention provides an image processing method shown in FIG. 1. FIG. 1 is a flowchart of an image processing method according to an embodiment of the present invention. As shown in FIG. 1, the image processing method includes the following method steps.

Step S202: Obtain a to-be-processed image and sensing data corresponding to the to-be-processed image.

Step S204: Obtain region-of-interest information of the to-be-processed image based on the sensing data.

Step S206: Determine a first image region and a second image region of the to-be-processed image based on the region-of-interest information, wherein the first image region is an image region determined based on the region-of-interest information, and the second image region is an image region other than the first image region in the to-be-processed image.

Step S208: Process the first image region in a first processing manner, and process the second image region in a second processing manner, wherein computation complexity of the first processing manner is higher than that of the second processing manner.

In the embodiments of the present invention, the to-be-processed image and the sensing data corresponding to the to-be-processed image are obtained; the region-of-interest information of the to-be-processed image is obtained based on the sensing data; the first image region and the second image region are determined based on the region-of-interest information, wherein the first image region is an image region determined based on the region-of-interest information, and the second image region is an image region other than the first image region in the to-be-processed image; and the first image region is processed in the first processing manner, and the second image region is processed in the second processing manner, wherein computation complexity of the first processing manner is higher than that of the second processing manner.

In the embodiments of the present invention, the region-of-interest information is obtained based on the sensing data corresponding to the to-be-processed image, so as to properly allocate limited computing power and increase complexity of an image processing algorithm for a core sensitive region in the region-of-interest information. In this way, the core sensitive area may present higher image processing quality, and thus improve overall processing performance of image processing.

Therefore, the embodiments of the present invention achieve the goal of improving overall image processing performance and yet still ensuring the image quality of regions of interests, and thus realize the technical effects of balancing image processing complexity and computational load. Furthermore, the problem of unable to improve overall image processing performance in the premise of ensuring image quality of regions of interests in conventional techniques can be resolved.

It should be noted that the image processing method provided by the embodiments of the present application is an enhanced processing scheme to conventional image signal processing (ISP). Obtaining the region-of-interest information (ROI information) of the to-be-processed image could benefit to improve the utilization efficiency of terminal-side computation capaabilities. Regarding implementation of obtaining the region-of-interest information, embodiments of the present invention adopt an algorithm based on dynamic vision sensor and spiking neural network, so as to obtain the ROI region at the front end of the ISP pipeline with relatively low power consumption and small area.

The image processing method provided in this embodiment of the present application may be applied to, but is not limited to, a graphics computing processor, for example, an ISP module or a fusion chip integrated with an ISP module. The fusion chip is mainly used for the following terminal products: an AI intelligent terminal, an attendance terminal, a video conference terminal, a portable smart camera, and a live broadcast terminal.

In an optional embodiment, the to-be-processed image includes a plurality of pixels, and the sensing data includes spatial domain information and time domain information corresponding to each of the plurality of pixels.

Optionally, the spatial domain information is sensing pixel position information, and the time domain information is sensing timing information.

In an optional embodiment, the sensing data is used to indicate event information in the to-be-processed image, wherein the data volume of the sensing data is smaller than the data volume of the to-be-processed image.

In an optional embodiment, the first processing manner is used for performing encoding/decoding processing and/or target identification processing on the first image region, and the second processing manner is used for performing encoding/decoding processing and/or target identification processing on the second image region.

It should be noted that, in the embodiments of the present invention, both the first image region and the second image region may be provided in plurality. For example, different interest levels for the to-be-processed image are determined based on the region-of-interest information, and the to-be-processed image is divided into a plurality of first image regions and a plurality of second image regions corresponding to different interest levels.

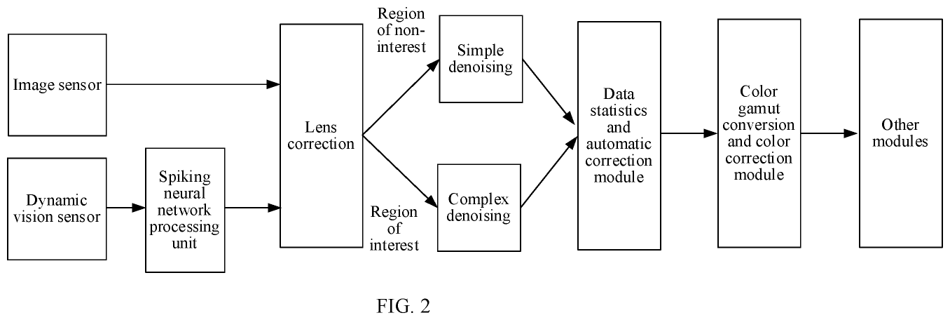

In an optional embodiment, a simplified schematic diagram of an implementation structure of the present invention is shown in FIG. 2. Optionally, an ISP implementation process may be used to implement sensor correction, lens correction, lens shading correction, data statistics and automatic correction processing, color gamut conversion and color correction processing (3Astats), and so on. In embodiments of the present invention, by incorporating an event-based dynamic vision sensor (Dynamic vision Sensor) and a corresponding spiking neural network processing unit (SNN), a region currently undergoing rapid changes (for example, a region with an falling old man in a picture) may be obtained through determination based on event information, and the event information is transmitted to the image signal processing ISP unit.

In an optional embodiment, once the event information is obtained, the processing manner of the image signal processing ISP unit in the image processing procedure may be adjusted based on the obtained event information. Optionally, the adjustment processing manner includes: using a relatively coarse denoising algorithm such as median filtering for a region of non-interest, and using a relatively strong denoising algorithm such as BM3D for the region of interest. If more complex algorithms are used for all regions, a computation overload problem may occur. Therefore, in the embodiments of the present invention, applying the limited computation resource to more important regions of interest can improve overall computing performance while ensuring image quality of key regions.

Through the use of the event-information-based region-of-interest extraction scheme proposed in embodiments of the present invention, the core of the solution of the present invention is to add a low-cost event sensor and a light-weight feature extraction network, so as to implement region-of-interest identification with relatively small area and low power consumption. Compared with the existing region-of-interest identification scheme, this solution has significant advantages in terms of the computation load and complexity, and therefore is very suitable for terminal-side deployment.

In an optional embodiment, the image processing method may be further applied to an intelligent image signal processing system for event-based region-of-interest identification. The system can properly allocate limited computing power based on the obtained region-of-interest information, to increase complexity of an image processing algorithm for key sensitive regions and present higher image quality, thereby improving overall system performance.

In an optional embodiment, the step of obtaining region-of-interest information of the to-be-processed image based on the sensing data includes:

S302: Obtain information about a first region of interest with a first event based on the spatial domain information and a first rule.

Optionally, the sensing data includes: spatial domain information and time domain information corresponding to each of the plurality of pixels.

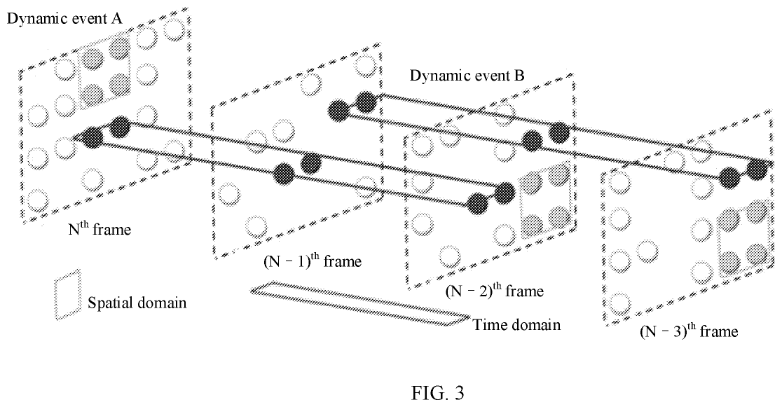

Optionally, the first event and the second event may be dynamic events, and event types of the dynamic events may be determined based on spatial domain feature and time domain feature, as shown in the embodiment of FIG. 3. For example, the first event and the second event may be a dynamic event A in spatial domain and a dynamic event B in time domain, respectively. Each white circle in FIG. 3 represents a pixel difference event, and each dashed box represents one frame. A feature extraction diagram of the dynamic event A in spatial domain indicates that, for each frame, a dynamic event in spatial domain may be generated if there occur events in all four pixels.

In the embodiment of the present invention, a working principle for determining a current ongoing dynamic event based on spatial domain feature and time domain feature is to extract an event feature based on the following four parameter variables: a: indicates a feature extraction region in a spatial range; α_threshold: indicates a threshold for a feature extraction region in the spatial range; T: indicates a feature extraction region in a time range; and T_threshold: indicates a threshold for a feature extraction region in the time range.

As shown in FIG. 3, a total of two dynamic events with event type A (Event type A) are generated in four frames, feature extraction parameters of the dynamic event A are: α=4, T=1, α_threshold=3, and T_threshold=0, which indicates that: for one frame with a 4-point region, it is considered that one dynamic event A is generated only when a dynamic event occurs on all the 4 points in the region (the threshold is 3 and what is greater than 3 is 4 points; and the threshold of T can be only 0 in a single-frame case).

The dynamic event A is in spatial domain, meaning that pixel change events occur in a region of the current frame, while the dynamic event B (Event type B) is in temporal domain, meaning that pixel change events occur at this point or region for several consecutive frames. A concept of space is added for the dynamic event B in comparison to the dynamic event A. The first parameter α represents the number of spatial features, the second parameter T represents the number of time frames, and the third parameter indicates that a dynamic event is generated only when the number of selected spatial points is greater than this parameter. Assuming that the first parameter α is 16 and the third parameter is 12, it means that one event is generated only when more than 12 of 16 points have time output, and the fourth parameter represents that in terms of time frame, a dynamic event is generated only when the number of frames is greater than this parameter.

It should be noted that the implementation described in FIG. 3 is only an exemplary embodiment of the image processing method provided based on FIG. 1. Various parameter conditions involved in FIG. 3 can be flexibly adjusted according to actual needs, and do not constitute a limitation of the present invention.

In an optional embodiment, the step of obtaining region-of-interest information of the to-be-processed image based on the sensing data includes:

Step S402: Obtain information about a second region of interest with a second event based on the spatial domain information, the time domain information, and a second rule.

Similar to the generation of the dynamic event A, feature extraction parameters of the dynamic event B are: α=2, T=3, α_threshold=1, and T_threshold=2. That is, two pixel differences occur in each frame, and one dynamic event B is generated when such phenomenon occurs in the spatial region for three consecutive frames. The feature extraction parameters indicate that for the 2-point region, a dynamic event B is generated when the following conditions are all satisfied: an event occurs at all points of this region and an event occurs in each of the three frames.

In an optional embodiment, the step of obtaining region-of-interest information of the to-be-processed image based on the sensing data includes:

Step S502: Perform data processing on the sensing data, by using a neural network model, to obtain the region-of-interest information.

Optionally, the neural network model may be an SNN, and the event sensor may be a dynamic vision sensor (DVS). Compared with the conventional ROI extraction technology, the event-based region-of-interest identification scheme proposed in the embodiment of the present application needs only analyzing the event information input from the DVS event sensor and performing data processing in order to obtain a region occurring changes in the current image and thus determine the region as a region of interest. The DVS event sensor and potential data processing algorithm such as SNN are both ultra-low power consumption units, generally with a total power consumption being less than 200 mW and without occupying a relatively large area, and therefore can be used at the front end of ISP to provide the region-of-interest information for ISP.

Optionally, data output by the DVS event sensor includes: a change with respect to an output of only one pixel. A positive pulse signal may be output if the brightness level of the pixel reaches a given brightness threshold, and a positive pulse signal is output if the brightness level reaches a give darkness threshold. It should be noted that the sensor array itself implies positional information, therefore it may represent pixel change status in a region.

In an optional embodiment, the step of obtaining region-of-interest information of the to-be-processed image based on the sensing data includes:

Step S602: Determine, based on the sensing data, whether each pixel included in the to-be-processed image is located in a region of interest, so as to obtain the region-of-interest information.

Compared with ISP without ROI support, the embodiment of the present application provides an intelligent image signal processing scheme in which region of interest is determined based on event, the region of interest may be obtained through simple calculation based on the information provided by the event sensor, and the obtained region-of-interest information may be introduced before ISP is started, so as to focus limited computing power on more important regions based on the ROI information, thereby improving image quality of the ROI region. This provides a basis for subsequent identification, improves an identification rate, and further improves competitiveness of the self-developed ISP module in the embodiment of the present invention.

In an optional embodiment, the step of obtaining the to-be-processed image and the sensing data includes:

Step S702: Obtain the to-be-processed image from an image acquisition apparatus and obtain the sensing data from an image motion sensing apparatus.

Optionally, the image motion sensing apparatus is an event sensor. In the embodiment of the present invention, the to-be-processed image may be obtained from an image acquisition apparatus and the sensing data may be obtained from the event sensor.

In the novel event-information-based region-of-interest extraction scheme proposed in the embodiments of the present invention, a low-cost event sensor is added to implement region-of-interest identification with a relatively small area and relatively low power consumption. Comparing with the existing region-of-interest identification scheme, the present invention has significant advantages in terms of the computation load and complexity, and therefore is very suitable for terminal-side deployment. The intelligent image signal processing system for event-based region-of-interest identification provided in the embodiment of the present application can properly allocate limited computing power based on the obtained region-of-interest information, and thus increase complexity of an image processing algorithm for a core sensitive region to present higher image quality, thereby improving overall system performance.

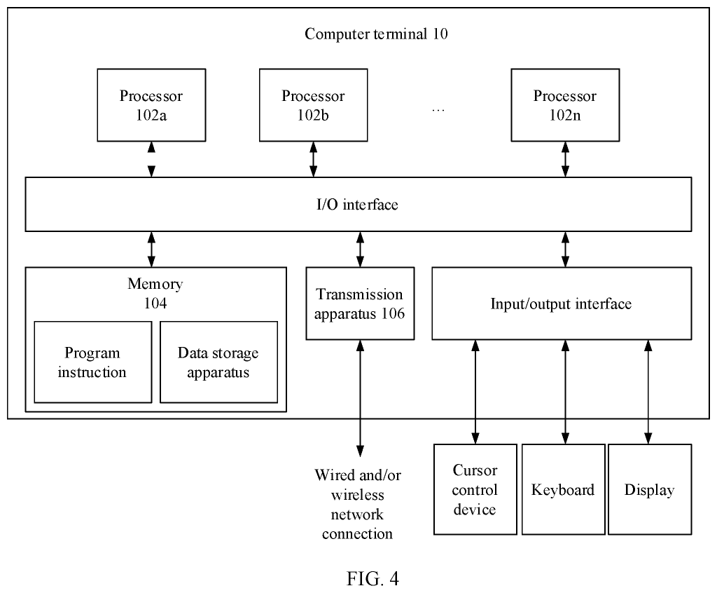

The method embodiment provided in Embodiment 1 of the present application may be executed on a mobile terminal, a computer terminal, or a similar computing apparatus. FIG. 4 is a block diagram of a hardware structure of a computer terminal (or a mobile device) for implementing an image processing method. As shown in FIG. 4, a computer terminal 10 (or a mobile device 10) may include one or more processors 102 (which are denoted as 102a, 102b, . . . , 102n in the figure) (the processor 102 may be, but is not limited to, a processing apparatus such as a micro processor MCU or a programmable logic device FPGA), a memory 104 for storing data, and a transmission apparatus 106 for communication functions. The computer terminal 10 may further include: a display, an input/output interface (I/O interface), a universal serial bus (USB) port (which may be included as one of ports of the bus), a network interface, a power supply, and/or a camera. Those of ordinary skill in the art can understand that the structure shown in FIG. 4 is merely for illustration and does not constitute any limitation on a structure of the electronic apparatus. For example, the computer terminal 10 may further include more or fewer components than those shown in FIG. 4, or have a configuration different from that shown in FIG. 4.

It should be noted that one or more processors 102 and/or other data processing circuits may be generally referred to as “data processing circuits” herein. The data processing circuit may be implemented partly or fully by software, hardware, firmware, or a combination thereof. Furthermore, the data processing circuit may be a single stand-alone processing module, or be incorporated partly or fully into any one of other elements in the computer terminal 10 (or mobile device). As involved in this embodiment of the present application, the data processing circuit acts as a processor for controlling (for example, selection of a variable resistance terminal path connected to the interface).

The memory 104 may be configured to store software programs of application software and modules, such as program instructions/data storage apparatuses corresponding to the image processing method in this embodiment of the present invention. By running the software programs and modules stored in the memory 104, the processor 102 executes various functional applications and data processing, to implement the foregoing image processing method. The memory 104 may include a high-speed random access memory, and may further include a non-volatile memory, for example, one or more magnetic storage apparatuses, a flash memory, or other non-volatile solid-state memories. In some examples, the memory 104 may further include a memory located remotely from the processor 102, and the remote memory may be connected to the computer terminal 10 through a network. Examples of the network include, but are not limited to, the Internet, an intranet, a local area network, a mobile communications network, and a combination thereof.

The transmission apparatus 106 is configured to receive or transmit data via a network. A specific example of the network may include a wireless network provided by a communications provider of the computer terminal 10. In one example, the transmission apparatus 106 includes a network interface controller (NIC), which may be connected to other network devices through a base station, so as to communicate with the Internet. In one example, the transmission apparatus 106 may be a radio frequency (Radio Frequency, RF) module, and is configured to wirelessly communicate with the Internet.

The display may be, for example, a touchscreen-type liquid crystal display (LCD), and the liquid crystal display enables a user to interact with the user interface of the computer terminal 10 (or mobile device).

It should be noted that, for ease of description, each foregoing method embodiment is described as a combination of a series of actions. However, persons skilled in the art should know that the present invention is not limited by the described action sequence because some steps may be performed in another sequence or simultaneously according to the present invention. In addition, those skilled in the art should also understand that all the embodiments described in this specification are merely exemplary embodiments, and the involved actions and modules are not necessarily mandatory to the present invention.

According to the foregoing description of the implementations, those skilled in the art may clearly understand that the methods in the foregoing embodiments may be implemented by using software in combination with a necessary common hardware platform, and certainly may alternatively be implemented by using hardware. However, in most cases, the former is a preferred implementation. Based on such an understanding, the technical solutions of the present invention essentially or the part contributing to the prior art may be implemented in a form of a software product. The software product is stored in a non-volatile storage medium (such as a ROM/RAM, a magnetic disk, or an optical disc), and includes several instructions for instructing a terminal device (which may be a mobile phone, a computer, a server, a network device, or the like) to perform the methods described in the embodiments of the present invention.

### Embodiment 2

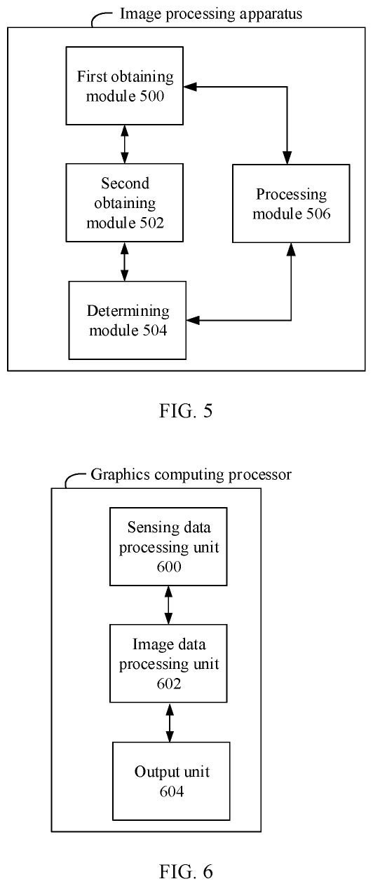

An embodiment of the present application further provides an apparatus for implementing the foregoing image processing method. FIG. 5 is a schematic structural diagram of an image processing apparatus according to an embodiment of the present invention. As shown in FIG. 5, the apparatus includes: a first obtaining module 500, a second obtaining module 502, a determining module 504, and a processing module 506.

The first obtaining module 500 is configured to obtain a to-be-processed image and sensing data corresponding to the to-be-processed image. The second obtaining module 502 is configured to obtain region-of-interest information of the to-be-processed image based on the sensing data. The determining module 504 is configured to determine a first image region and a second image region of the to-be-processed image based on the region-of-interest information, wherein the first image region is an image region determined based on the region-of-interest information, and the second image region is an image region other than the first image region in the to-be-processed image. The processing module 506 is configured to process the first image region in a first processing manner, and process the second image region in a second processing manner, where computational complexity of the first processing manner is higher than that of the second processing manner.

It should be noted herein that the first obtaining module 500, the second obtaining module 502, the determining module 504, and the processing module 506 correspond to the steps S202 to S208 in Embodiment 1, respectively. Embodiments and application scenarios implemented by the four modules are the same as those implemented by the corresponding steps, and are not limited to the content disclosed in Embodiment 1. It should be noted that, as a part of the apparatus, the modules may run on the computer terminal 10 provided in Embodiment 1.

It should be noted that, for preferred implementation of this embodiment, reference may be made to the related description in Embodiment 1, and details are not repeated herein.

### Embodiment 3

An embodiment of the present application further provides an embodiment of a graphic processing unit. FIG. 6 is a schematic structural diagram of the graphic processing unit according to an embodiment of the present application. As shown in FIG. 6, the graphic processing unit includes: a sensing data processing unit 600, an image data processing unit 602, and an output unit 604.

The sensing data processing unit 600 is configured to obtain a to-be-processed image and sensing data corresponding to the to-be-processed image, and obtain region-of-interest information of the to-be-processed image based on the sensing data. The image data processing unit 602 is configured to: determine a first image region and a second image region of the to-be-processed image based on the region-of-interest information, and process the first image region in a first processing manner and process the second image region in a second processing manner so as to obtain a processed image, wherein the first image region is an image region determined based on the region-of-interest information, the second image region is an image region other than the first image region in the to-be-processed image, and computational complexity of the first processing manner is higher than that of the second processing manner. The output unit 604 is configured to output the processed image.

In the embodiment of the present invention, the to-be-processed image and the sensing data corresponding to the to-be-processed image are obtained; the region-of-interest information of the to-be-processed image is obtained based on the sensing data; the first image region and the second image region are determined based on the region-of-interest information, wherein the first image region is an image region determined based on the region-of-interest information, and the second image region is an image region other than the first image region in the to-be-processed image; and the first image region is processed in the first processing manner, and the second image region is processed in the second processing manner, wherein computation complexity of the first processing manner is higher than that of the second processing manner.

In the embodiment of the present application, the region-of-interest information is obtained based on the sensing data corresponding to the to-be-processed image, so as to properly allocate limited computing power and increase complexity of an image processing algorithm for a core sensitive region in the region-of-interest information. In this way, the core sensitive area presents higher image processing quality, and thus further improves overall processing performance of image processing.

Therefore, embodiments of the present invention achieve the goal of improving overall image processing performance and yet still ensuring the image quality of regions of interests, and thus realize the technical effects of balancing image processing complexity and computational load. Furthermore, the problem of being unable to improve overall image processing performance in the premise of ensuring image quality of regions of interests in conventional techniques can be resolved.

It should be noted that the graphic processing unit provided in the embodiments of the present application is an enhanced processing scheme for image signal processing (ISP). Obtaining the region-of-interest information (ROI information) of the to-be-processed image helps improve utilization efficiency of terminal-side computing performance and improve ISP performance. In implementation of obtaining the region-of-interest information, an algorithm based on a dynamic vision sensor and a neural pulse network are adopted in the embodiments of the present application, so as to obtain the ROI region at the front end of the ISP pipeline with relatively low power consumption and a relatively small area.

The image processing method provided in the foregoing embodiment of the present invention may be applied to, but is not limited to, a graphic processing unit in the embodiments of the present application, for example, an image signal processing (ISP) hardware IP (IOT fusion chip). The fusion chip is mainly used for the following terminal products: an AI intelligent terminal, an attendance terminal, a video conference terminal, a portable smart camera, and a live broadcast terminal.

In an optional embodiment, the to-be-processed image includes a plurality of pixels, and the sensing data includes spatial domain information and time domain information corresponding to each pixel of the plurality of pixels.

Optionally, the spatial domain information is sensing pixel position information, and the time domain information is sensing timing information.

In an optional embodiment, the sensing data is used to indicate event information in the to-be-processed image, wherein a data volume of the sensing data is smaller than a data volume of the to-be-processed image.

In an optional embodiment, a data processing capability of the sensing data processing unit is lower than that of the image data processing unit.

In an optional embodiment, the first processing manner is used for performing encoding/decoding processing and/or target identification processing on the first image region, and the second processing manner is used for performing encoding/decoding processing and/or target identification processing on the second image region.

In an optional embodiment, a simple schematic diagram of an implementation structure of the present application is shown in FIG. 2. In FIG. 2, sensor correction, lens shading, data processing, and the like are all part of implementation process of ISP. In the embodiments of the present invention, an event-based dynamic vision sensor and a corresponding spiking neural network processing unit (SNN) are included, and determination is performed based on the event information to obtain a region currently undergoing rapid changes (for example, a region showing a fallen old man in a picture), and transmit the event information to the ISP unit.

In an optional embodiment, upon obtaining the event information, the ISP unit adjusts subsequent ISP processing manners based on the obtained event information. Optionally, the adjustment processing manner includes: using a relatively coarse denoising algorithm such as median filtering for a region of non-interest, and using a relatively strong denoising algorithm such as BM3D for the region of interest. If complex algorithms are used for all regions, a computation overload problem may occur. Therefore, applying the limited computation resource to more important regions of interest can improve overall computing performance while ensuring image quality of key regions.

For the event-information-based region-of-interest extraction scheme proposed in the embodiments of the present application, the core of the present application is to add a low-cost event sensor and a light-weight feature extraction network, so as to implement region-of-interest identification with a relatively small area and relatively low power consumption. Compared with the existing region-of-interest identification scheme, this solution has a lot of advantages in terms of the computation load and complexity, and therefore is very suitable for terminal-side deployment.

In an optional embodiment, the image processing method may be further applied to an intelligent image signal processing system for event-based region-of-interest identification. The system can properly allocate limited computing power based on the obtained region-of-interest information, to increase complexity of an image processing algorithm for a core sensitive region and present higher image quality, thereby improving overall system performance.

In an optional embodiment, the sensing data unit includes: a first event processing module, configured to obtain information about a first region of interest with a first event based on the spatial domain information and a first rule; and a second event processing module, configured to obtain information about a second region of interest with a second event based on the spatial domain information, the time domain information, and a second rule.

Optionally, the sensing data includes: spatial domain information and time domain information that are corresponding to each pixel in the plurality of pixels.

Optionally, the first event and the second event may be dynamic events, and an event type of the dynamic event is determined based on spatial domain feature and time domain feature, as shown in FIG. 3. For example, the first event and the second event may be a dynamic event A in spatial domain and a dynamic event B in time domain, respectively. Each white circle in FIG. 3 represents a pixel difference event, and each dashed box represents one frame. A feature extraction diagram of the dynamic event A in spatial domain indicates that, for each frame, a dynamic event in spatial domain may be generated if there occur events at all four pixels.

In the embodiment of the present application, a working principle for determining a current ongoing dynamic event based on spatial domain feature and time domain feature is to extract an event feature based on the following four parameter variables: a: indicates a feature extraction region in a spatial range; a threshold: indicates a threshold for a feature extraction region in the spatial range; T: indicates a feature extraction region in a time range; and T_threshold: indicates a threshold for a feature extraction region in the time range.

As shown in FIG. 3, a total of two dynamic events with event type A are generated in four frames, feature extraction parameters of the dynamic event A are: α=4, T=1, a threshold=3, and T_threshold=0, which indicates that: for one frame with a 4-point region, it is considered that one dynamic event A is generated only when a dynamic event occurs on all the 4 points in the region (the threshold is 3 and it can only be satisfied if event occurs on all of the 4 points; and the threshold of T can only be 0 for a single-frame scenario).

The dynamic event A is in spatial domain, meaning that pixel change events occur at a region of the current frame, while the dynamic event B (Event type B) is in temporal domain, meaning that pixel change events occur at a point or region for several consecutive frames. A concept of space is added for the dynamic event B in comparison to the dynamic event A. The first parameter α represents the number of spatial features, the second parameter T represents the number of time frames, and the third parameter indicates that one dynamic event is generated only when the number of selected spatial points is greater than this parameter. Assuming that the first parameter α is 16 and the third parameter is 12, it means that one event is generated for the entire region only when more than 12 of 16 points have time output, and the fourth parameter represents a parameter in terms of time frame, a dynamic event is generated only when the number of consecutive frames having outputs is greater than this parameter.

Similar to a manner of the dynamic event A generation, feature extraction parameters of the dynamic event B are: α=2, T=3, α_threshold=1, and T_threshold=2. That is, a dynamic event B is generated in the condition that two pixel differences occur in a spatial region of a frame, and such phenomenon occurs in the spatial region for three consecutive frames. The feature extraction parameters indicate that for the 2-point region, a dynamic event B is generated when the following conditions are all satisfied: an event occurs at all points of this region and the event occurs in each of three consecutive frames.

Compared with ISP without ROI support, the embodiment of the present application provides an intelligent image signal processing scheme in which region of interest is determined based on event, the region of interest may be obtained through simple calculation based on the information provided by the event sensor, and the obtained region-of-interest information may be introduced before ISP is started, so as to focus limited computing power on more important regions based on the ROI information, thereby improving image quality of the ROI region. This provides a basis for subsequent identification, improves an identification rate, and further improves competitiveness of the self-developed ISP module in this embodiment of the present application.

In the novel event-information-based region-of-interest extraction scheme proposed in the embodiment of the present application, a low-cost event sensor is added to implement region-of-interest identification with a relatively small area and relatively low power consumption. Comparing with the existing region-of-interest identification scheme, present invention has significant advantages in terms of the computation load and complexity, and therefore is very suitable for terminal-side deployment. The intelligent image signal processing system for event-based region-of-interest identification provided in the embodiment of the present application can properly allocate limited computing power based on the obtained region-of-interest information, and thus increase complexity of an image processing algorithm for a core sensitive region to present higher image quality, thereby improving overall system performance.

It should be noted that, for preferred implementation of this embodiment, reference may be made to the related description in Embodiment 1, and details are not repeated herein.

### Embodiment 4

An embodiment of the present invention further provides an image processing system, including: a graphics processing unit; and a memory that is connected to the graphics processing unit and configured to provide the graphics processing unit with instructions for performing the following processing steps:

obtaining a to-be-processed image and sensing data corresponding to the to-be-processed image; obtaining region-of-interest information of the to-be-processed image based on the sensing data; determining a first image region and a second image region of the to-be-processed image based on the region-of-interest information, wherein the first image region is an image region determined based on the region-of-interest information, and the second image region is an image region other than the first image region in the to-be-processed image; and processing the first image region in a first processing manner, and processing the second image region in a second processing manner, wherein computation complexity of the first processing manner is higher than that of the second processing manner.

In the embodiment of the present invention, the to-be-processed image and the sensing data corresponding to the to-be-processed image are obtained; the region-of-interest information of the to-be-processed image is obtained based on the sensing data; the first image region and the second image region are determined based on the region-of-interest information, wherein the first image region is an image region determined based on the region-of-interest information, and the second image region is an image region other than the first image region in the to-be-processed image; and the first image region is processed in the first processing manner, and the second image region is processed in the second processing manner, wherein computation complexity of the first processing manner is higher than that of the second processing manner.

In the embodiment of the present application, the region-of-interest information is obtained based on the sensing data corresponding to the to-be-processed image, so as to properly allocate limited computing power and increase complexity of an image processing algorithm for a core sensitive region in the region-of-interest information. In this way, the core sensitive area presents higher image processing quality, to further improve overall processing performance of image processing.

Therefore, embodiments of the present invention achieve the goal of improving overall image processing performance and yet still ensuring the image quality of regions of interests, and thus realize the technical effects of balancing image processing complexity and computational load. Furthermore, the problem of being unable to improve overall image processing performance in the premise of ensuring image quality of regions of interests in conventional techniques can be resolved.

It should be noted that, for preferred implementation of the embodiment, reference may be made to the related description in Embodiment 1, and details are not repeated herein.

### Embodiment 5

Embodiments of the present application further provides a computer terminal, and the computer terminal may be any computer terminal device in a computer terminal group. Optionally, in the embodiment, the computer terminal may alternatively be replaced by a terminal device such as a mobile terminal.

Optionally, in the embodiment, the computer terminal may be at least one of a plurality of network devices located in a computer network.

In the embodiment, the computer terminal may execute program code of an image processing method comprising following steps: obtaining a to-be-processed image and sensing data corresponding to the to-be-processed image; obtaining region-of-interest information of the to-be-processed image based on the sensing data; determining a first image region and a second image region of the to-be-processed image based on the region-of-interest information, wherein the first image region is an image region determined based on the region-of-interest information, and the second image region is an image region other than the first image region in the to-be-processed image; and processing the first image region in a first processing manner, and processing the second image region in a second processing manner, wherein computation complexity of the first processing manner is higher than that of the second processing manner.

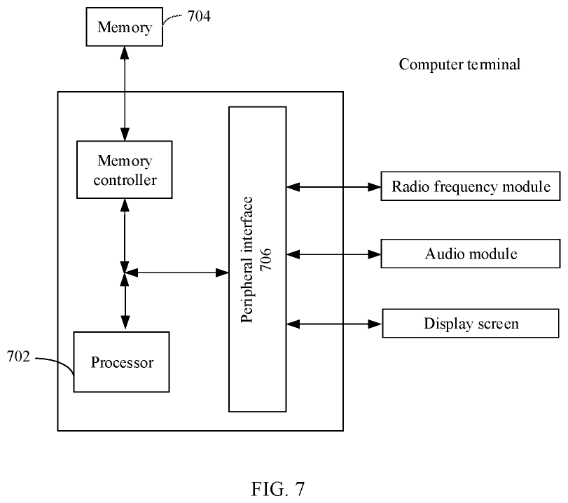

Optionally, FIG. 7 is another structural block diagram of computer terminal according to an embodiment of the present application. As shown in FIG. 7, the computer terminal may include: one or more processors 702 (only one is shown in the figure), a memory 704, and a peripheral interface 706.

The memory may be used to store software programs and modules, such as software programs and modules corresponding to the image processing method and apparatus provided by the embodiments of the present invention. By running the software programs and modules stored in the memory, the processor executes various functional applications and data processing so as to implement the foregoing image processing method. The memory may further include a high-speed random access memory, and may further include a non-volatile memory, for example, one or more magnetic storage apparatuses, a flash memory, or other non-volatile solid-state memories. In some embodiments, the memory may further include a memory located remotely from the processor, and the remote memory may be connected to the computer terminal through a network. Examples of the network include, but are not limited to, the Internet, an intranet, a local area network, a mobile communications network, and a combination thereof.

The processor may invoke the information and application programs stored in the memory by using the transmission apparatus, so as to perform the following steps: obtaining a to-be-processed image and sensing data corresponding to the to-be-processed image; obtaining region-of-interest information of the to-be-processed image based on the sensing data; determining a first image region and a second image region of the to-be-processed image based on the region-of-interest information, wherein the first image region is an image region determined based on the region-of-interest information, and the second image region is an image region other than the first image region in the to-be-processed image; and processing the first image region in a first processing manner, and processing the second image region in a second processing manner, wherein computation complexity of the first processing manner is higher than that of the second processing manner.

Optionally, the processor may further execute program code of the following step: obtaining information about a first region of interest with a first event based on the spatial domain information and a first rule.

Optionally, the processor may further execute program code of the following step: obtaining information about a second region of interest with a second event based on the spatial domain information, the time domain information, and a second rule.

Optionally, the processor may further execute the program code of the following step: performing data processing on the sensing data by using a neural network model, to obtain the region-of-interest information.

Optionally, the processor may further execute the program code of the following step: determining, based on the sensing data, whether each pixel included in the to-be-processed image is located in a region of interest, so as to obtain the region-of-interest information.

Optionally, the processor may further execute the program code of the following step: obtaining the to-be-processed image from an image acquisition apparatus and obtain the sensing data from an image motion sensing apparatus.

The embodiments of the present invention provide an image processing scheme. The to-be-processed image and the sensing data corresponding to the to-be-processed image are obtained; the region-of-interest information of the to-be-processed image is obtained based on the sensing data; the first image region and the second image region are determined based on the region-of-interest information, wherein the first image region is an image region determined based on the region-of-interest information, and the second image region is an image region other than the first image region in the to-be-processed image; and the first image region is processed in the first processing manner, and the second image region is processed in the second processing manner, wherein computation complexity of the first processing manner is higher than that of the second processing manner.

In the embodiments of the present application, the region-of-interest information is obtained based on the sensing data corresponding to the to-be-processed image, so as to properly allocate limited computing power and increase complexity of an image processing algorithm for a core sensitive region in the region-of-interest information. In this way, the core sensitive area presents higher image processing quality, to further improve overall processing performance of image processing.

Therefore, embodiments of the present invention achieve the goal of improving overall image processing performance and yet still ensuring the image quality of regions of interests, and thus realize the technical effects of balancing image processing complexity and computational load. Furthermore, the problem of being unable to improve overall image processing performance in the premise of ensuring image quality of regions of interests in conventional techniques can be resolved.

Those of ordinary skill in the art can understand that the structure shown in FIG. 7 is merely for illustration, and the computer terminal can alternatively be a terminal device such as a smart phone (such as an Android mobile phone or an iOS mobile phone), a tablet computer, a wearable smart device, a notebook computer, a desktop computer, a smart home device, an IoT smart device, an Internet of Vehicle device, or a mobile Internet device (Mobile Internet Devices, MID). FIG. 7 does not constitute any limitation on the structure of the foregoing electronic apparatus. For example, the computer terminal may further include more or fewer components (for example, a network interface and a display apparatus) than those shown in FIG. 7, or have a configuration different from that shown in FIG. 7.

A person of ordinary skill in the art may understand that all or some of the steps of the methods in the embodiments may be implemented by a program instructing relevant hardware of the terminal device. The program may be stored in a computer-readable non-volatile storage medium. The non-volatile storage medium may include a flash memory, a read-only memory (Read-Only Memory, ROM), a random access memory (Random Access Memory, RAM), a magnetic disk, an optical disc, or the like.

### Embodiment 6

An embodiment of the present application further provides an embodiment of a non-volatile storage medium. Optionally, in this embodiment, the non-volatile storage medium includes a stored program, where when the program is executed, a device in which the non-volatile storage medium is located is controlled to perform the image processing method described above.

Optionally, in the embodiment, the non-volatile storage medium may be located in any computer terminal of a computer terminal group in a computer network, or be located in any mobile terminal of a mobile terminal group.

Optionally, in the embodiment, the non-volatile storage medium is configured to store program code for performing the following steps: obtaining a to-be-processed image and sensing data corresponding to the to-be-processed image; obtaining region-of-interest information of the to-be-processed image based on the sensing data; determining a first image region and a second image region of the to-be-processed image based on the region-of-interest information, wherein the first image region is an image region determined based on the region-of-interest information, and the second image region is an image region other than the first image region in the to-be-processed image; and processing the first image region in a first processing manner, and processing the second image region in a second processing manner, wherein computation complexity of the first processing manner is higher than that of the second processing manner.

Optionally, in the embodiment, the non-volatile storage medium is configured to store program code for performing the following step: obtaining information about a first region of interest with a first event based on the spatial domain information and a first rule.

Optionally, in the embodiment, the non-volatile storage medium is configured to store program code for performing the following step: obtaining information about a second region of interest with a second event based on the spatial domain information, the time domain information, and a second rule.

Optionally, in the embodiment, the non-volatile storage medium is configured to store program code for performing the following step: performing data processing on the sensing data by using a neural network model, to obtain the region-of-interest information.

Optionally, in the embodiment, the non-volatile storage medium is configured to store program code for performing the following step: determining, based on the sensing data, whether each pixel included in the to-be-processed image is located in a region of interest, so as to obtain the region-of-interest information.

Optionally, in the embodiment, the non-volatile storage medium is configured to store program code for performing the following step: obtaining the to-be-processed image from an image acquisition apparatus and obtain the sensing data from an image motion sensing apparatus.

The sequence numbers of the preceding embodiments of the present invention are merely for description purpose but do not indicate the preference of the embodiments.

In the foregoing embodiments of the present invention, the description of each embodiment has respective focuses. For a part that is not described in detail in an embodiment, reference may be made to related descriptions in other embodiments.

In the plurality of embodiments provided in the present invention, it should be understood that the disclosed technical content may be implemented in other manners. The described apparatus embodiment is merely exemplary. For example, the division of units is merely logical function division and may be implemented by other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the units or modules may be implemented in electronic or other forms.

The components described as separate parts may or may not be physically separate, and parts illustrated as units may or may not be physical units, may be located in one position, or may be distributed on a plurality of network elements. Some or all of the units may be selected based on actual requirements to achieve the objectives of the solutions of the embodiments.

In addition, functional units in the embodiments of the present invention may be integrated into one processing unit, or each of the units may exist as physically individual unit, or two or more units are integrated into one unit. The integrated unit may be implemented in a form of hardware, or may be implemented in a form of a software functional unit.

If the integrated unit is implemented in the form of a software functional unit and sold or used as an independent product, the integrated unit may be stored in a computer-readable non-volatile storage medium. Based on such an understanding, the technical solutions of the present invention essentially, or the part contributing to the prior art, or all or a part of the technical solutions may be implemented in a form of a software product. The software product is stored in a non-volatile storage medium and includes several instructions for instructing a computer device (which may be a personal computer, a server, or a network device) to perform all or a part of the steps of the methods described in the embodiments of the present invention. The foregoing non-volatile storage medium includes: any medium that can store program code, such as a USB flash drive, a read-only memory (ROM, Read-Only Memory), a random access memory (RAM, Random Access Memory), a removable hard disk, a magnetic disk, or an optical disc.

The foregoing descriptions are exemplary implementation manners of the present invention. It should be noted that a person of ordinary skill in the art may make several improvements and modifications without departing from the principle of the present invention and the improvements and modifications shall fall within the protection scope of the present invention.

What is claimed is:

1. An image processing method, comprising:
obtaining a to-be-processed image and sensing data corresponding to the to-be-processed image;
obtaining region-of-interest information of the to-be-processed image based on the sensing data;
determining a first image region and a second image region of the to-be-processed image based on the region-of-interest information, wherein the first image region is an image region determined based on the region-of-interest information, and the second image region is an image region other than the first image region in the to-be-processed image; and
processing the first image region in a first processing manner, and processing the second image region in a second processing manner, wherein computation complexity of the first processing manner is higher than that of the second processing manner.

2. The image processing method according to claim 1, wherein the to-be-processed image comprises a plurality of pixels, and the sensing data comprises spatial domain information and time domain information corresponding to each of the plurality of pixels.

3. The image processing method according to claim 2, wherein the spatial domain information is sensing pixel position information, and the time domain information is sensing timing information.

4. The image processing method according to claim 2, wherein the obtaining region-of-interest information of the to-be-processed image based on the sensing data comprises:
obtaining information about a first region of interest with a first event based on the spatial domain information and a first rule.

5. The image processing method according to claim 4, wherein the first rule comprises at least spatial feature parameter and spatial feature threshold.

6. The image processing method according to claim 2, wherein the obtaining region-of-interest information of the to-be-processed image based on the sensing data comprises:
obtaining information about a second region of interest with a second event based on the spatial domain information, the time domain information, and a second rule.

7. The image processing method according to claim 6, wherein the second rule comprises at least spatial feature parameter, temporal feature parameter, spatial feature threshold parameter, and temporal feature threshold parameter.

8. The image processing method according to claim 1, wherein the sensing data is used to indicate event information in the to-be-processed image, and a data volume of the sensing data is smaller than a data volume of the to-be-processed image.

9. The image processing method according to claim 1, wherein the obtaining region-of-interest information of the to-be-processed image based on the sensing data comprises:
performing data processing on the sensing data by using a neural network model, to obtain the region-of-interest information.

10. The image processing method according to claim 1, wherein the obtaining region-of-interest information of the to-be-processed image based on the sensing data comprises:
determining, based on the sensing data, whether each pixel comprised in the to-be-processed image is located in a region of interest, so as to obtain the region-of-interest information.

11. The image processing method according to claim 1, wherein the obtaining a to-be-processed image and sensing data corresponding to the to-be-processed image comprises:
obtaining the to-be-processed image from an image acquisition apparatus; and
obtaining the sensing data from an image motion sensing apparatus.

12. The image processing method according to claim 1, wherein the first processing manner is used for performing codec processing and/or target identification processing on the first image region, and the second processing manner is used for performing codec processing and/or target identification processing on the second image region.

13. A non-volatile storage medium, wherein the non-volatile storage medium comprises a stored program, and when the program runs, a device in which the non-volatile storage medium is located is controlled to perform the image processing method according to claim 1.

14. An image processing apparatus, comprising:
a first obtaining module, configured to obtain a to-be-processed image and sensing data corresponding to the to-be-processed image;
a second obtaining module, configured to obtain region-of-interest information of the to-be-processed image based on the sensing data;
a determining module, configured to determine a first image region and a second image region of the to-be-processed image based on the region-of-interest information, wherein the first image region is an image region determined based on the region-of-interest information, and the second image region is an image region other than the first image region in the to-be-processed image; and
a processing module, configured to process the first image region in a first processing manner, and process the second image region in a second processing manner, wherein computational complexity of the first processing manner is higher than that of the second processing manner.

15. A graphics computing processor, comprising:
a sensing data processing unit, configured to obtain a to-be-processed image and sensing data corresponding to the to-be-processed image, and obtain region-of-interest information of the to-be-processed image based on the sensing data;
an image data processing unit, configured to: determine a first image region and a second image region of the to-be-processed image based on the region-of-interest information, and process the first image region in a first processing manner and process the second image region in a second processing manner, so as to obtain a processed image, wherein the first image region is an image region determined based on the region-of-interest information, the second image region is an image region other than the first image region in the to-be-processed image, and computational complexity of the first processing manner is higher than that of the second processing manner; and
an output unit, configured to output the processed image.

16. The graphics computing processor according to claim 15, wherein the sensing data processing unit comprises:
a first event processing module, configured to obtain information about a first region of interest with a first event based on the spatial domain information and a first rule; and
a second event processing module, configured to obtain information about a second region of interest with a second event based on the spatial domain information, the time domain information, and a second rule.

17. The graphics computing processor according to claim 16, wherein the first rule comprises at least spatial feature parameter and spatial feature threshold, and the second rule comprises at least spatial feature parameter, temporal feature parameter, spatial feature threshold parameter, and temporal feature threshold parameter.

18. The graphics computing processor according to claim 15, wherein the sensing data processing unit has a lower data processing capability than the image data processing unit.

19. The graphics computing processor according to claim 15, wherein the sensing data is used to indicate event information in the to-be-processed image, and a data volume of the sensing data is smaller than a data volume of the to-be-processed image.

20. An image processing system, comprising:
the graphics computing processor according to claim 15; and
a memory, connected to the graphics computing processor and configured to provide the graphics computing processor with an instruction for processing the following processing steps:
obtaining a to-be-processed image and sensing data corresponding to the to-be-processed image;
obtaining region-of-interest information of the to-be-processed image based on the sensing data;
determining a first image region and a second image region of the to-be-processed image based on the region-of-interest information, wherein the first image region is an image region determined based on the region-of-interest information, and the second image region is an image region other than the first image region in the to-be-processed image; and
processing the first image region in a first processing manner, and processing the second image region in a second processing manner, wherein computation complexity of the first processing manner is higher than that of the second processing manner.
